(19) United States
(12) Patent Application Publication
(10) Pub. No.: US 2014/0055422 A1
(43) Pub. Date: Feb. 27, 2014

(54) SYSTEM AND METHOD FOR SENSING MULTI-TOUCH SURFACES BY DETECTION OF LIGHT SCATTER VIA A FRONTAL IMAGE

(71) Applicants: Marcelo Ferreira Guimarães, Florianopolis (BR); Renato Parenti Turcato, Florianopolis (BR); George Tavares, Florianopolis (BR)

(72) Inventors: Marcelo Ferreira Guimarães, Florianopolis (BR); Renato Parenti Turcato, Florianopolis (BR); George Tavares, Florianopolis (BR)

(73) Assignee: SABIA EXPERIENCE TECNOLOGIA S/A

(21) Appl. No.: 14/111,102

(22) PCT Filed: Apr. 14, 2011
(86) PCT No.: PCT/BR2011/000109

§ 371 Date: Oct. 10, 2013

(51) Int. Cl. G02F 1/1333

(52) U.S. Cl. CPC G02F 1/13338
USPC 345/175

(57) ABSTRACT

“System and method for multi-touch surface sensing by detection of light spreading through front image”, more particularly developed for composing a new technology especially applied to electronic equipment that use screens with touch-screen technology; the system comprises a set of devices that includes one or more video cameras positioned over a screen or interactive surface, an image projector placed at a distance in relation to the screen or interactive surface, such projector projects an image directed to said surface; one or more video cameras are coupled with a control board, that is responsible for activating LEDs, and to a method operated by software installed in a computer or dedicated hardware; being the software responsible for applying the method for treating and processing of captured images for determining the position of multiple touches executed on the surface or screen due to the light scattering phenomenon present in the touch point occurred from the interaction of various surfaces that compose the screen with its optical medium and of its synchronism with light emitted by LEDs positioned in its edge.

### CROSS REFERENCE TO RELATED APPLICATIONS

The present application is a U.S. National Stage of PCT/BR2011/000109, filed Apr. 14, 2011, titled “SYSTEM AND METHOD FOR SENSING MULTI-TOUCH SURFACES BY DETECTION OF LIGHT SCATTER VIA A FRONTAL IMAGE”. The entire contents of the foregoing are incorporated herein by reference.

### TECHNICAL FIELD

The present invention relates to a system and method for sensing of multi-touch surfaces through detection of the spreading of light of the frontal image, particularly of a technology that has been specially developed to be applied to electronic equipments that use interactive screens with embedded sensing, also known as touch-screen technology, with capacity for processing of multiple and simultaneous touches. The system developed can be for individual or group usage.

### BACKGROUND OF THE INVENTION

Equipments that use the touch-screen technology have been in the market for a while, especially those that deal with one-touch events. Their most common use is in displays of self-service terminals.

The appearing of multiple touch touch-screen technology is a worldwide tendency that started with the introduction in the market of smart-phones with displays sensible to double touch. This and other devices use multiple discrete sensors where each sensor monitors a respective point. Usually are used capacitive or resistive sensors built from transparent electric material deposited over an LCD type surface. The identification system with capacitive sensors is built using two very thin plates separated by a spacer. When the screen is touched, an alteration in the electric fields of the capacitors is caused. This alteration is perceived and the coordinates are sent to the computer. This information is translated by a program that transforms touch in an on screen command.

Another type of device currently in the market are equipments in the shape of tables and interactive panels that use optical systems based on the Frustrated Total Internal Reflection—FTIR. In this technology, a plate of translucent material is used as an optical guide for light applied to its edge and a video camera placed under the surface is used to capture a continuous sequence on images of the mentioned surface. When the surface is touched by one or more users the contact of the user's skin with the surface interferes in the internal reflection of light due to a physical phenomenon. Such phenomenon generates light spots correspondent to the touched areas, which are detected by the video camera positioned under the surface. A proper software processes the video frames in real time identifying the coordinates of the touched spots and transmitting them to computer applications which can then use the multi-touch surface as an input device. This technology is partially used by the applicant in its products and can be seen in PCT application “Electronic equipment provided with a compact optical sensing module connected to a projection module for on-board electronic equipments with touch sensitive screen and other interactive devices”. The FTIR principle has been known for a long time being first featured in U.S. Pat. No. 3,200,701—“Method for Optical Comparison of Skin Friction-Ridge Patterns” of August, 1965 and U.S. Pat. No. 4,484,179—“Touch Position Sensitive Surface” of November, 1984. Other patents documents on this subject: U.S. Patent 20080179507—Application Publication “Multi-touch Sensing Display Through Frustrated Total Internal Reflection”.

Another technology known as “acoustic wave screens” allows 100% of luminosity through the screen. Different from other technologies, it does not place any metallic plates under the display. Instead, two transducers are placed in each side of the screen, a receptor and a transmitter in the sides, top and bottom forming a square. The transmitter transducer sends a small wave that is perceived by the receptor transducer. This information form then a grid of coordinates. When something touches the screen, receptors perceive an interruption in the flow of information and automatically inform the coordinate of the touch, translation this as an on screen command

Many are documents related to touch-screen technology such as documents US 2009314621 (Apple), US 2008094356 (Apple), US 2009006991 (Nokia), among others.

In view of the exposure of the documents above, such technologies present a few inconveniences such as the fact that the technologies of capacitive sensing present a technical limitation for treatment of more than 10 simultaneous touches in surfaces bigger than 20 inches. So the use of capacitive technology limits the size and number of touches treated. As it will be seen below, due to the fact that the product within this application and others products from the applicant are for collective use, the capacitive technology is not adequate for so and therefore has limited application.

On the other side, multi-touch surfaces that use the optical principle of FTIR are presently available in the market in the shape of interactive tables and panels that are hard to be transported. The height of the tables (in case of horizontal surfaces) and the depth of the panels (in the case of vertical surfaces) is, typically, equal to about half the dimension of the diagonal surface. For example, for a multi-touch device with a 60 inches diagonal. The depth of the device is of about 30 inches or 75 cm. In the case of the panels it is possible to get a false impression of the thinness of the surface embedding it to a wall or division wall but the difficulty for handling and transportation remains due to the real proportions of the device.

Moreover, interactive tables and panels that use optical technology there is a big thickness due to the need of positioning the camera on the surface opposite to the users. This camera is within a distance big enough so that the captured image comprehends the entire surface. Even with the use of wide angle lenses such distance, as said above, equals approximately half the dimension of the diagonal surface. The aperture angle of the lenses possible to be used is limited by the introduction of distortions in the image with consequent loss of resolution, what compromises the performance of the device.

### SUMMARY OF THE INVENTION

The present system or new technology developed by the applicant was motivated by the intention of reducing the thickness of the interactive touch screen surface for making it an extremely fine board. This technology is based on hardware composed by one or more video cameras positioned over the interactive surface that are coupled to a dedicated controller and to a software for processing the captured images allowing treatment and discrimination of multiple touches executed on the surface.

Thus, the objective of the present invention is to allow reduction of the thickness of the interactive table for making it a simple board. For such the camera for capturing images has been repositioned on top of the interactive surface and appropriate hardware and software have been projected for capture and adequate treatment of the images acquired.

It is another objective of the invention to discriminate and treat the multiple dots generated on the table by the users, that is, there is no limit for the amount of touches that can be treated.

A considerable advantage is in the fact that the technology developed allows building equipments with horizontal surfaces as fine as a board and vertical surfaces as fine as wall paintings.

Facing the objectives and advantages described above, sums up the fact that through the reduction of the thickness considerable reduction in the weight of the screen shaped device is obtained and easier handling and transportation of the same.

### DESCRIPTION OF THE DRAWINGS

Supplementing the present description for a better comprehension of the characteristics of the present invention and according to a preferred embodiment of the same, an attached set of drawings follows the description in which in illustrative but not limiting way is represented its functioning:

FIG. 1 illustrates a diagram of the system for sensing of multi-touch surfaces through detection of the spreading of light of the frontal image;

FIG. 2 represents the preferred option for composition of the screen used in the system;

FIG. 3 shows the spreading of light in the optical medium that composes the screen used in the innovating system; and

FIG. 4 represents a block diagram of the method for treating images employed by the software of the present system.

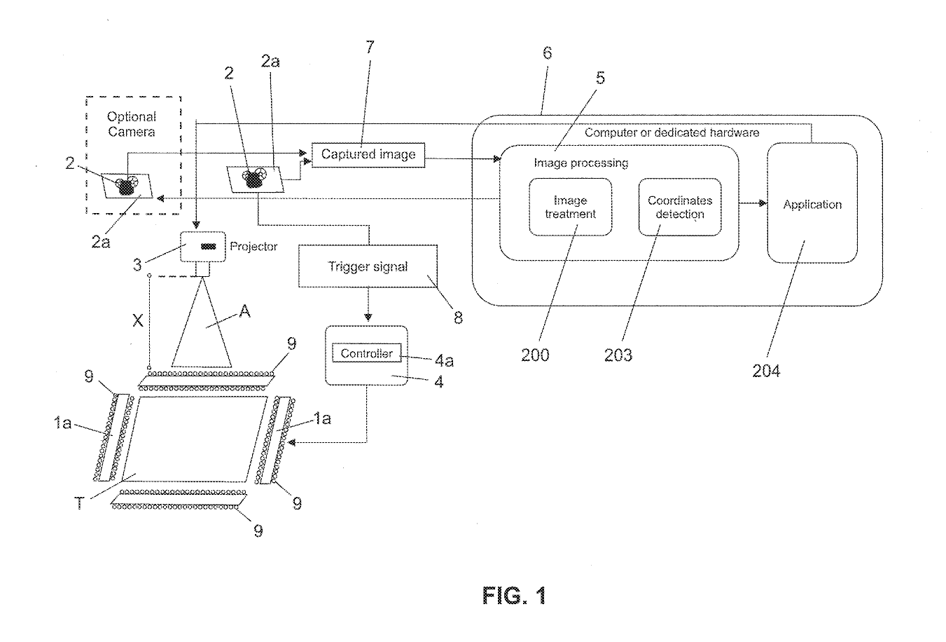

### DETAILED DESCRIPTION OF THE INVENTION

According to the illustrations, the present invention refers to a new “SYSTEM AND METHOD FOR MULTI-TOUCH SURFACE SENSING BY DETECTION OF LIGHT SPREADING THROUGH FRONT IMAGE” system (S) more particularly developed for composing a new technology especially applied to electronic equipment that use screens (T) with embedded sensing, also known as touch-screen technology.

According to the present invention, system (S) comprises a set of devices that include more specifically one or more video cameras (2) positioned over a screen or interactive surface (T), an image projector (3) placed at a distance (x) in relation to the interactive surface (T), such projector projects an image (A) directed to said surface (T); one or more video cameras (2) is/are coupled with a dedicated control board (4) and to a method operated by software (5) installed in a computer or dedicated hardware (6) being the software (5) responsible for the processing of captured images (7) for treatment and discrimination of multiple touches executed on the surface.

The software (5) for acquisition of captured image (7) commands the sensing element (2a) of the camera (2) for acquisition of image for a determined time. This period of time is known as “shutter aperture time” analog to the term “shutter” that characterizes the diaphragm opening mechanism of conventional cameras. For instance, camera (2) generates an electric signal (8) when the sensing element (2a) of camera (2) initiates acquisition of image of this first frame. This electric signal (8) is captured by the control board (4) that has a dedicated controller (4a).

System (S) reckons that the control board (4) id responsible for activating the infra-red light emitting elements—LEDs—(9) through a pre-programmed period when detects for the first time the electric signal (8) emitted by sensor (2a) of the camera (2) referring to image acquisition. That is, LEDs (9) are synchronized through the controlling plate with the acquisition of the image being captured.

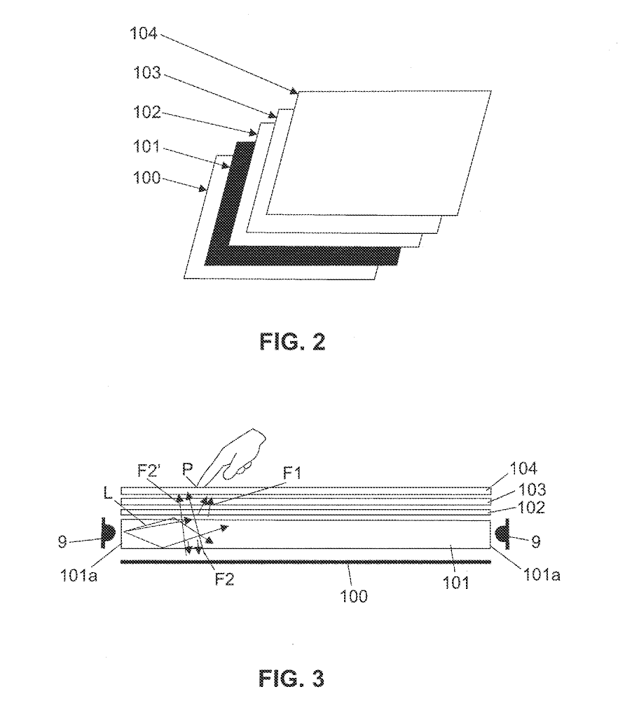

A preferential embodiment for screen (T) (see FIG. 02) that integrates the present system (S) comprehends a series of overlaid panels according to the following sequence (from bottom to top): (a) reflecting membrane (100); (b) optical medium (101); (c) diffuser membrane (102); (d) projection screen (103); and (e) optional protection membrane (104).

The optical medium (101) is conformed by rigid translucent plate, preferentially made of a polymer such as acrylic or another adequate material and is prepared for assembling of LEDs (9) in the edges (101a), and the LEDs light the optical medium through the command of the control board (4).

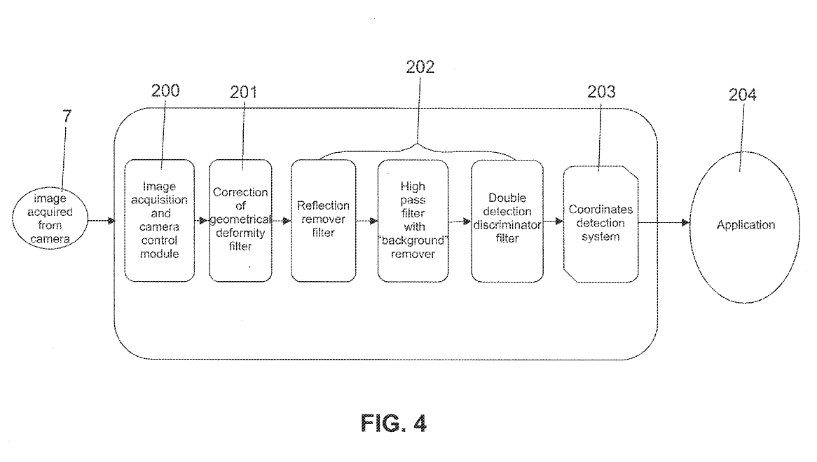

While the screen (T) is not touched, light generated by LEDs (9) reflects internally within the optical medium (101), which has its edge properly adjusted for this purpose. Light (L) (FIG. 04) is guided within the optical medium (101) by internal reflection due to the difference of index of refraction between the optical medium (101) material, preferentially acrylic, and the other surfaces (100, 102) that compose screen (T) forming, with this, a waveguide for light (L) generated by the LEDs (9) in the edge (101a).

When screen (T) is touched by the user, it deforms and transmits this point of contact to the diffuser membrane (102) which is manufactured with material especially developed to react with the material of the optical medium (101) allowing the light (L) to escape from its interior. This physical principle is known as FTIR (Frustrated Total Internal Reflection). Part of the light that escapes the optic medium (101) upwards (FI) crosses the diffuser membrane (102) and the projection screen (103) and the protection membrane (104) lighting the contact point (P). Other portion of the light (L) that escapes downwards (F2) reflects on the reflecting membrane (100) and goes back upwards (F2′) amplifying the amount of light present on screen (T). Such light is captured by one or more cameras (2).

In other words, the system of the present invention comprises an integration among elements that cooperate to constitute the screen (T), that is built by overlapped panels in the following configuration:

reflecting membrane (100) cooperating with the optical medium (101) to reflect upwards to contact point P any light that escapes downward from the optical medium (101) in which said light is reflected upwards to point of contact P, crossing sequentially said optical medium (101), diffuser membrane (102), projection screen (103) and protection membrane (104);

optical medium (101) for internal reflection of light generated by LEDs co-operating with the interaction of diffuser membrane (102) that undergoes transmission of the deformation of contact with the projection screen (103) in which a portion of the light generated for said optical medium is directed upwards crossing the diffuser membrane (102) and a portion of the light generated for said optical measure is directed downwards in the direction of the reflecting membrane (100);

diffuser membrane (102) for interaction with optical medium (101) that contributes so that a portion of light directed upwards originated from optical medium (101) and a portion of the light directed upwards originated from reflecting membrane (100) are directed by said diffuser membrane (102) to cross sequentially the projection screen (103) and the protection membrane (104) to point of contact P;

projection screen (103) for reception of image (A) projected by projector device (3) in which is carried out the deformation of point of contact P, which contributes for reception of the amount of light that crosses diffuser membrane (102) to contact point P; and

protection membrane (104) of contact surface overlapped over projection screen (103).

In a second frame camera(s) (2) generate(s) a new electric pulse (8) to control board (4) when image is acquired by sensor (2a) of camera (2), however control board (4) disregards such second pulse and does not activate LEDs (9). At this moment, with LEDs off, occurs acquisition or capture of the second image (7).

Captures images (7) in both moments are received by camera control and image acquisition module (200) foreseen in the software (5). Such process continues repetitively with acquisition of images of the odd frames being synchronized with LEDs on and the capture of even frames synchronized with LEDs off. The software (5) processes captured images through the following method (FIG. 4):

a) first are applied filters (201) for improvement of images and correction of geometric deformity deriving from camera positioning;

b) then it is applied mathematical treatment (202) by software of the image acquired in the first moment using as reference the image of the second moment; through this treatment it is removed all image noise deriving from present signals that can generate false acquisition as for example reflections in random objects;

c) treated image is processed in detection system (203) to generate the coordinates of the table, and then delivered to the software of the application (204).

In other words, the present invention also provides a method for sensing of multi-touch surfaces by detection of spreading of light of the frontal image, comprising the following steps:

projecting image (A) through a projector device (3) over an interactive surface of screen (T) within a distance (x) in relation to said screen or interactive service (T), configuring a projection screen (103);

lighting the optical medium through a control board (4) commanding lighting of the LEDs (9) positioned in the lateral edges (101a);

receiving a contact point P of pressure on screen (t) or projection screen (103) transmitting deformity of contact to the diffuser membrane (102) so that a first portion of the light escapes from the optical medium (101) upwards (F1), crossing sequentially diffuser membrane (102), projection screen (103) and protection membrane (104) lighting point of contact (P), and a second portion of light (L) escapes downward (F2) reflecting on reflecting membrane (100) and directing itself upwards (F2′), crossing sequentially diffuser membrane (102), projection screen (103), and protection membrane (104) lighting point of contact (P);

activating video cameras (2) for image acquisition (7) generated over a screen or interactive surface (T) capturing the portions of light that illuminate point of contact (P) in moments in odd frames, when is generated an electric signal (8) captured by control board (4) of dedicated controller (4a) in which said control board (4) activates LEDs (9) for a pre-programmed period when it detects for the first time the electric signal (8) sent by sensor (2a) of camera (2);

activating video cameras (2) for acquisition of image (7) generated over a screen or interactive surface (T) capturing the portions of light that light point of contact (P) in moments in even frames, when it is generated an electric signal (8) that is disregarded by dedicated controller (4a), not activating LEDs (9) for a pre-programmed period; and

processing of the captures images (7) in both moments by a camera control and image acquisition module (200) through a software (5), applying filters (201) for improvement of the quality of images and correction of geometrical deformities deriving from camera positioning, treating the image acquires at the moment mathematically (202) by software using as reference the second frame image, and processing it in detection system (203) to generate table coordinates being then delivered to the application software (204).

Optionally two simultaneous cameras for image capture can be used. This setting allows an improvement in acquisition of areas of the table that may have a view obstructed by the user's hand. In this case a software treatment for connection of generated images is executed.

Is certain that when the present invention is put to practice modifications can be introduced in what refers to certain details of assembling and configuration not causing dismissal of fundamental principles that are clearly described in the claims being understood that terminology used had the purpose of non-limitation.

1-8. (canceled)

9. Method for multi-touch surface sensing by detection of light spreading through front image comprising the steps of:
projecting image through a projector device over an interactive surface of screen within a distance in relation to said screen or interactive surface, configuring a projection screen;
lighting the optical medium through a control board commanding lighting of the LEDs positioned in the lateral edges;
receiving a contact point of pressure on screen or projection screen transmitting deformity of contact to the diffuser membrane so that a first portion of the light escapes from the optical medium upwards, crossing sequentially diffuser membrane, projection screen, and protection membrane lighting point of contact, and a second portion of light escapes downward reflecting on reflecting membrane and directing itself upwards, crossing sequentially diffuser membrane, projection screen, and protection membrane lighting point of contact;
activating video cameras for image acquisition generated over a screen or interactive surface capturing the portions of light that illuminate point of contact in moments in odd frames, when is generated an electric signal captured by control board of dedicated controller in which said control board activates LEDs for a pre-programmed period when it detects for the first time the electric signal sent by sensor of camera;
activating video cameras for acquisition of image generated over a screen or interactive surface capturing the portions of light that light point of contact in moments in even frames, when it is generated an electric signal that is disregarded by control board of the dedicated controller, not activating LEDs for a pre-programmed period; and
processing the captured images in both moments by a camera control and image acquisition module trough a software, applying filters for improvement of the quality of images and correction of geometrical deformities deriving from camera positioning, treating the image acquires at the moment mathematically by software using as reference the second frame image, and processing it in detection system to generate table coordinates being then delivered to the application software.

10. System for multi-touch surface sensing by detection of light spreading through front image, comprising
the screen is built by overlapped panels in the following configuration:
reflecting membrane cooperating with the optical medium to reflect upwards to contact point any light that escapes downward from the optical medium in which said light is reflected upwards to contact point, crossing sequentially said optical medium, diffuser membrane, projection screen, and protection membrane;
optical medium for internal reflection of light generated by LEDs co-operating with the interaction of diffuser membrane that undergoes transmission of the deformation of contact with the projection screen in which a portion of the light generated for said optical mean is directed upwards crossing the diffuser membrane, and a portion of the light generated for said optical medium is directed downwards in the direction of the reflecting membrane;
diffuser membrane for interaction with optical medium that contributes so that a portion of light directed upwards originated from optical medium and a portion of the light directed upwards originated from reflecting membrane are directed by said diffuser membrane to cross sequentially the projection screen and the protection membrane to point of contact;
projection screen for reception of image projected by projector device in which is carried out the deformation of point of contact, which contributes for reception of the amount of light that crosses diffuser membrane to contact point; and protection membrane of contact surface overlapped over said projection screen.

11. System for multi-touch surface sensing by detection of light spreading through front image, according to claim 10 comprising optical medium being shaped as a hard translucent plate and being built in acrylic or other polymer.
